(19) United States
(12) Patent Application Publication
(10) Pub. No.: US 2006/0120567 A1
(43) Pub. Date: Jun. 8, 2006

(54) Imaging of primary eyewear for remote production of secondary eyewear

(75) Inventors: Avri Kvartler, Modi'in (IL); Boris Shichvarg, Haifa (IL); Amir Rick, Modi'in (IL)

Correspondence Address: MORGAN LEWIS & BOCKIUS LLP, 1111 PENNSYLVANIA AVENUE NW, WASHINGTON, DC, 20004, US

(73) Assignee: Opti-Clip Internationl LLC

(21) Appl. No.: 11/076,423

(22) Filed: Mar. 10, 2005

Related U.S. Application Data
(60) Provisional application No. 60/632,940, filed on Dec. 6, 2004.

(51) Int. Cl. G06K 9/00

(52) U.S. Cl. 382/111

(57) ABSTRACT

A method of providing image information regarding primary eyewear to a remote production center where secondary eyewear is to be produced based thereon. The method comprises the steps of obtaining with an imaging device an image of the primary eyewear suitable for obtaining therefrom image data indicative of at least one geometric characteristic of the primary eyewear, providing to the production center reference data associated with the primary eyewear, and transmitting the image data via an external communication means to the production center for production there of the secondary eyewear based on the image and reference data. The reference data is representative of at least one reference dimension.

### FIELD OF THE INVENTION

The present invention is in the general field of obtaining an outline of primary eyewear, such as eyeglasses, for generating secondary eyewear, such as clip-ons whose lenses are readily mountable on and in registration with the eyeglass frame.

### BACKGROUND OF THE INVENTION

There are known in the art many types of add-on units that are fitted onto eyeglass frames or lenses. An example is a clip-on that matches in size and shape the eyeglass frame or lenses and is configured to be readily mounted thereon. Typically, such a clip-on has dark lenses, and when used, can convert conventional eyeglasses (having optical lenses) to sunglasses. Clip-ons are thus quite popular, since they are compact and insofar as the user is concerned, the need to have separate optical eyeglasses and sunglasses is obviated.

US 20030101603 (hereinafter, “the US application”) of the applicant, discloses a system for imaging a pair of eyeglasses and obtaining data indicative of the outline of the eyeglasses and designated locations associated with the outline. The system is useful for custom forming, on a non-industrial scale, clip-ons adapted to be used with eyeglasses. The system includes a positioning device for placing the eyeglasses thereon, an imaging device for acquiring an image of the eyeglasses, a processor associated with a cutting machine, in which the clip-ons, with their associated holes and slots, are cut according to an editable outline and supplemental locations, the processor being configured to calculate an editable outline for each eyepiece of the eyeglasses and a display to display the outline, such that the editable outline can be compared to its respective eyepiece. The processor is further configured to calculate supplemental locations linked to the outline for manufacturing holes and/or slots that anchor clip-on parts that include bridge and legs, and to provide data indicative of the specified outline and supplemental locations.

### SUMMARY OF THE INVENTION

According to one aspect of the present invention, there is provided a method of providing image information regarding primary eyewear to a remote production center where secondary eyewear is to be produced based thereon. The method comprises the steps of obtaining with an imaging device an image of the primary eyewear suitable for obtaining therefrom image data indicative of at least one geometric characteristic of the primary eyewear, providing to the production center reference data associated with the primary eyewear, and transmitting the image data via an external communication means to the production center for production there of the secondary eyewear based on the image and reference data. The reference data is representative of at least one reference dimension.

It should be noted that hereinafter in the specification and claims the term eyewear is to be understood as eyeglasses, sunglasses, eyeglass frames, clip-on attachments for eyeglasses, and the like. It should further be noted that the term remote, as it relates to a production center, is to be understood as at a site different from the imaging device. Conversely, with regard to an imaging device, the term remote is to be understood as at a site different from the production center. The term external, as it relates to a communication means, refers to a third-party communication infrastructure, such as the PSTN, cellular communication backbone, the internet, or the like.

At the production center, the image data may be manipulated so that the secondary eyewear will be produced having a size and shape that correspond to those of the eyeglasses.

According to one embodiment, the imaging device comprises a camera objective and a CCD (e.g., a digital camera). According to one modification of this embodiment, the imaging device is integrated with a cellular communication device, which may be adapted to transmit at least the image data to the production center.

According to another embodiment, the imaging device is a photocopying machine. According to a further embodiment, the image data is transmitted using a facsimile machine.

When desired, the production center may comprise means to convert an image to digital data, such as a computer scanner.

The reference data may include two mutually perpendicular dimensions. These may by measurements of the height and width of at least part of the primary eyewear. Alternatively, these may be provided by imaging an object of known dimensions, such as a sticker placed on the primary eyewear during imaging, providing the reference data.

According to another aspect of the present invention, there is provided a platform, adapted to hold primary eyewear and an imaging device at a predetermined mutual disposition, such that the imaging device is positioned to image the primary eyewear.

According to one modification, the platform comprises a cover adapted to prohibit lighting conditions unfavorable to clearly imaging the primary eyewear. According to another modification, the platform comprises a backlight positioned so that the primary eyewear is retained between it and the imaging device. The intensity of the light may be adjustable. According to a further modification, the distance between the primary eyewear and the imaging device may be adjusted. According to a still further modification, the primary eyewear is eyeglasses, and the platform is adapted to hold the eyeglasses such that the temples are not imaged by the imaging device. According to a still further modification, the platform is adapted to hold a cellular phone having a digital camera integrated therein.

According to a further aspect of the present invention, there is provided a production center comprising a processor adapted to receive and process images of primary eyewear acquired by a remote imaging device, to determine the real size of the primary eyewear, and to generate instructions for the production of secondary eyewear based thereon. The production center further comprises a production machine adapted to receive the instructions from the processor and to produce the secondary eyewear based thereon.

According to one embodiment, the processor is further adapted to calculate an editable frame outline of the primary eyewear. According to another embodiment, the processor is further adapted to calculate supplemental data for the production of the secondary eyewear. The supplemental data may be locations associated with the outline for attachment of anchoring parts. The processor may comprise several computers.

The present invention has several advantages, among which is the possibility of producing custom eyewear, such as clip-ons, made to be used with primary eyewear, such as eyeglasses, without requiring a customer to be in proximity to a production center. A system or network comprising a production center and a plurality of remote sites provided with an imaging device may be established, enabling a customer to have his eyeglasses imaged at a site convenient to him, and have clip-ons produced at the production center and sent to him.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic representation of a system for producing clip-ons according to the present invention;

FIGS. 2 through 6 are perspective views of platforms according to several embodiments of the present invention; and

FIG. 7 is a front view of a pair of eyeglasses with a sticker according to one embodiment of the present invention.

### DETAILED DESCRIPTION EMBODIMENTS

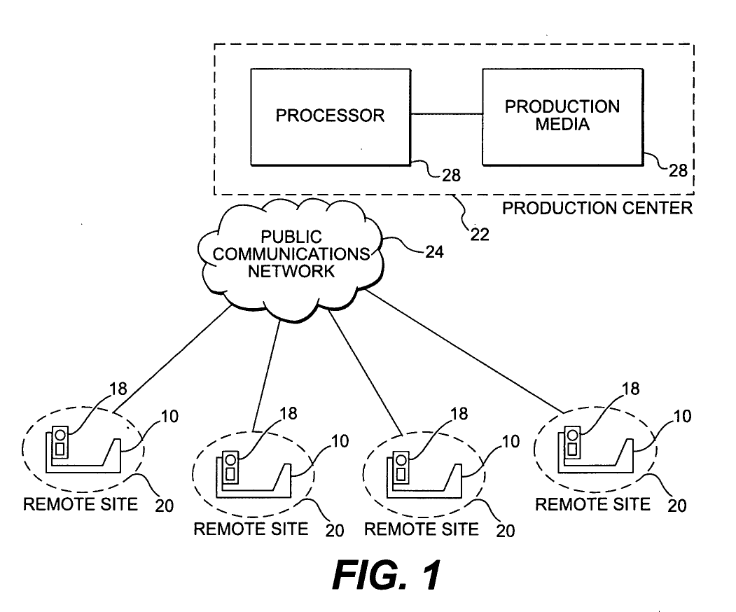

FIG. 1 is a schematic representation of a system using a method for producing clip-ons for eyeglasses by a production center 22 using a remote imaging device 18, in accordance with one embodiment of the present invention. In this case, eyeglasses constitute primary eyewear, and clip-ons constitute secondary eyewear.

According to the method, a customer brings his eyeglasses to one of several remote sites 20. Each remote site comprises an imaging device 18 for imaging eyeglasses and equipment for transmitting the image to the production center over external communication means.

The imaging device 18 is preferably a digital imaging device such as a cellular phone equipped with a camera objective and a CCD, but it may be any device adapted to acquire an image and convert it to a digital bitmap that can be transmitted, including, but not limited to, a digital SLR camera, a digital video camera adapted to capture “still” pictures, a webcam, a computer scanner, a fax machine, or fax software. The imaging device 18 may be a camera objective and a CCD in an e-mail enabled cellular phone. In this way, a digital image may be acquired and transmitted from a single piece of equipment at the remote site 20. Alternatively, the device 18 may be a non-digital imaging device such as a conventional camera. In that case, the image may be converted to a digital bitmap either at the remote site 20 or at the production center 22.

The image, having been acquired at the remote site 20, is transmitted to the production center 22 via the external communication means. When the remote site transmits a digital file, either acquired directly by a digital imaging device, or converted from an image produced by a non-digital imaging device, the equipment may be any device capable of sending digital files via a public communication network 24, preferably using electronic mail, but it may use any appropriate protocol, including, but not limited to, a VPN tunnel designated for that purpose or an open file drop-off server.

In the case that an image has been captured by a non-digital imaging device and has not been converted to a digital format at the remote site, the external communication means may be, for example, a courier or the PSTN. In the case that the PSTN is used as the external communication means, a fax machine or fax software may be used. Once the image is received by the production center, it is converted to a digital format. Alternatively, the production center 22 may be provided with software adapted to receive a fax transmission and automatically convert the transmission to a digital image.

In addition, reference data which is used to determine the real size of the eyeglasses is also provided to the production center. This information may comprise measurements of the height and width of at least one of the eyeglasses' lenses. In the art, and subsequently in this specification, these are referred to as A (width) and B (height) dimensions. These measurements are transmitted to the production center with the image, in order to determine the actual size of the glasses. Alternatively, this information may be a predetermined dimension, such as the distance between the imaging device and the eyeglasses, or a reference dimension imaged together with the eyeglasses, may be used to determine, at the production center, the real size of the glasses.

As shown in FIG. 7, a sticker 30 of known dimensions may be placed on the lens of the eyeglasses during imaging. Use of the sticker 30 obviates the need to take A and B measurements of the eyeglasses. When the image of the eyeglasses with the sticker 30 is transmitted to the production center, it is scaled so that the image of the sticker represents the known true size of the sticker. This ensures that the image also reflects the true size of the eyeglasses.

It should be noted that the entire front of the eyeglasses need not be imaged. It is sufficient that an area encompassing one entire lens and the entirety of the bridge be imaged. Since eyeglasses are typically symmetrical about the bridge, the image of the lens not imaged can be extrapolated by the processor. In the event of non-symmetrical eyeglasses, both lenses must be imaged.

In operation, the image of the eyeglasses is transmitted to the production center, for example, via electronic mail. Included in the transmission may be information about the eyeglasses and/or clip-ons, including, but not limited to, lens type, lens color, hardware color, curvature of the eyeglasses (base 6/8), and glasses and frame thickness. Upon receipt of the transmission, an order is opened and an order number assigned. A physical ticket, having the order information encoded on a barcode is printed, and the order is placed in a job queue. The ticket is associated with a tray. When the tray reaches a dispatcher, the order is retrieved from the system using the encoded information. The order information is retrieved, the clip-ons are produced (as described below), and the order information is copied to a data server, which is periodically backed up.

Prior to production, the image is scaled, based on the information provided, to represent the actual size of the eyeglasses. In the event that A and B dimensions are sent, this is accomplished by considering the width, in pixels, of the A dimension of the image of a lens, and dividing it by the measured A dimension. This ratio is used to horizontally scale the image. A similar calculation is performed for the vertical dimension of the image. These two calculations are carried out independently of one another, since, especially in the event of a facsimile transmission, one dimension may be disproportionately “stretched” or “compressed,” resulting in a distorted image. In the event that the distance from the camera objective to the eyeglasses or the imaged reference dimension is sent, the size of the eyeglasses may be geometrically extrapolated from that information and from the size of the image of the eyeglasses.

Sending the A and B dimensions has the advantage that in a case where the front face of the eyeglasses has a significant curvature, the geometric extrapolation used to determine the size of the eyeglasses will be flawed, since that calculation is based on an assumption of a planar eyeglasses front face.

The image is analyzed by the processor in order to determine the location of the edges of the eyeglasses. Due to noise inherent to digital imaging, the edge detection may be enhanced by the algorithm described in the US application, paragraphs 109 to 121, which are incorporated herein by reference.

Generally speaking, the outline of the eyeglasses is sought. Where, for example, the eyeglasses include a frame, the sought outline is the external outline of the frame. By another example, where the eyeglasses are rimless (i.e., they have no frame), the sought outline corresponds to the external margins of the eyeglass lenses.

It should be noted that redundant eyeglass parts, such as the temple and bridge, do not constitute parts of the sought outline.

Specific procedures are performed by the processor concerning image alignment and enhancement, as described in the US application, paragraphs 130 and 131, and, more explicitly, paragraphs 145-179, which are incorporated herein by reference along with the figures referenced therein.

One important feature is that the outline is editable, as it is displayed in a manner which enables the user to compare the outline to the respective eyepiece contour (e.g., in the case of eyeglasses with a frame, to the external contour of the frame). By one embodiment, the outline is superposed on the frame image, and is displayed in a distinguishable manner, for example, by displaying the frame image in one color and the outline in another color. Due to the editable characteristics of the outline and the fact that it can be easily compared to the eyeglasses' image, the user can readily apply minor modifications, if necessary, in order to adjust the outline to substantially match the contour of the eyeglass fame and thereby assure substantial registration of the so-manufactured clip-on with the eyeglasses. The modifications can be realized by an interface, e.g. as provided in commercially available drawing software (such as Free Hand™).

The processor further calculates supplemental data (e.g., locations of holes and slots to which clip-on parts such as the clips and bridge are to be anchored).

The outline and supplemental data are provided to a production machine, which cuts the clip-on lenses and produces the holes at the designated locations (as prescribed by the supplemental data) to thereby facilitate the assembly of the clip-on. Once assembled, the clip-ons are sent either to the customer or to the remote site for customer pick-up.

Each remote site 20 is preferably provided with a support on which eyeglasses may be disposed for imaging. It may further be provided with means for holding the imaging device. The eyeglasses support and the imaging device holding means may constitute parts of a platform 10.

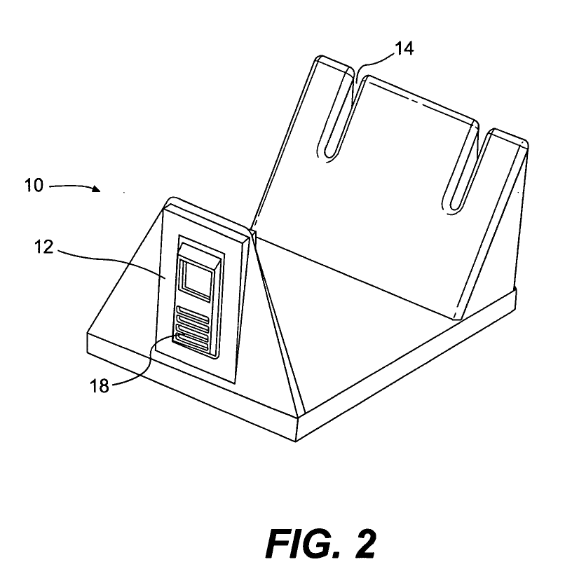

FIG. 2 shows one embodiment of such a platform. The platform 10 comprises a grip 12 which may be made of molded plastic adapted to grasp a specific imaging device. Alternatively, the grip 12 may be made of a viscoelastic material, or of any material suitable to retain the imaging device 18, without causing damage thereto, so that the camera objective is disposed toward a support 14, and the shutter release button is accessible. The grip 12 may be easily adjustable to retain a range of imaging devices, for example, a range of cell phones enabled with digital cameras so that the imaging system is not limited for use with one or a few models of cell phones. It may optionally be removable from the platform 10, and replaceable by another grip adapted to hold a different range of imaging devices, such as substantially different cellular phones or a digital SLR camera.

The support 14 is adapted to retain the eyeglasses so that the front face thereof is facing the camera objective of the digital imaging device, and is substantially parallel to the CCD of the imaging device. In this way, the distortion of the image of the eyeglasses is reduced. The support 14 may be adapted to retain the eyeglasses in such a way so that the temples are not seen, such as with two or more slits or apertures positioned to receive the temples in such a way to that the eyeglasses are positioned as described above. When the eyeglasses are thus held, the stems are not viewable by the digital imaging device 18.

A backlight illumination source may be disposed such that the eyeglasses are retained between it and the digital imaging device 18, all having a common optical axis passing through the CCD. It is useful for eliminating shadows that would increase the amount of editing needed by the acquired image. The intensity of the light is optionally adjustable.

The platform 10 may optionally comprise a portion, disposed behind the glasses, having a regular pattern. In this way, the edges of frameless or partially frameless lenses can be determined by a user when the image is edited by the distortion of the pattern due to the eyeglass lens. The pattern may be colored, and the colors may be selected so that they do not substantially appear in the frame of the eyeglasses. In this way, a software filter may be provided to selectively remove or ignore the pattern during processing.

The platform may optionally comprise more than one section, thus permitting the support to be moved further away from or closer to the grip.

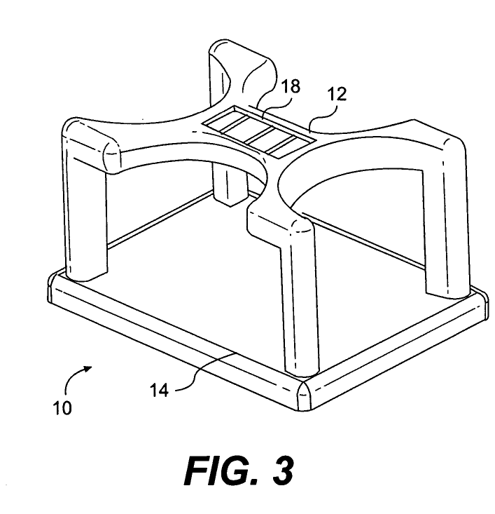

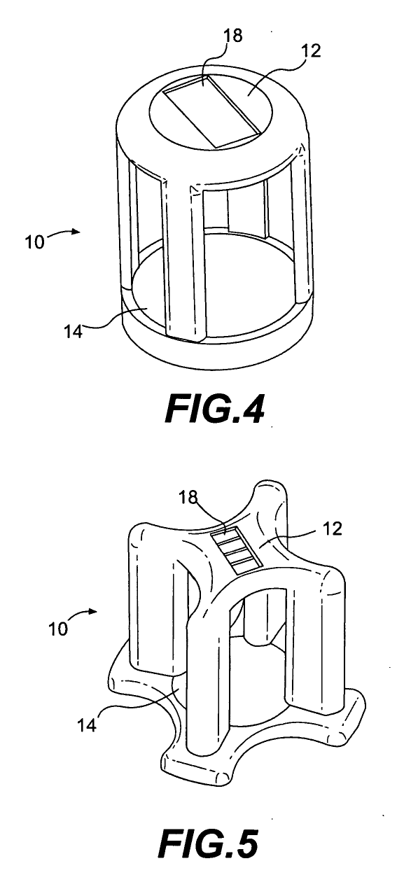

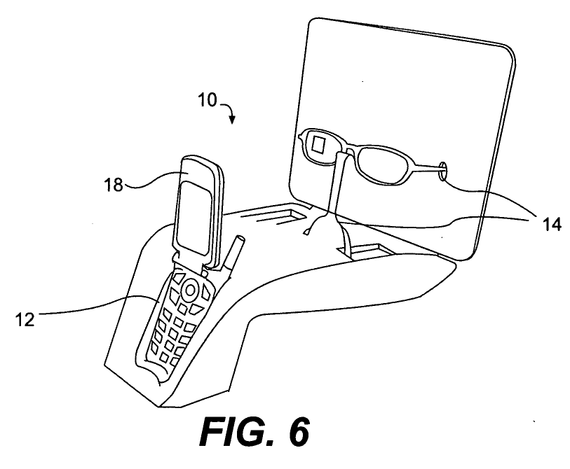

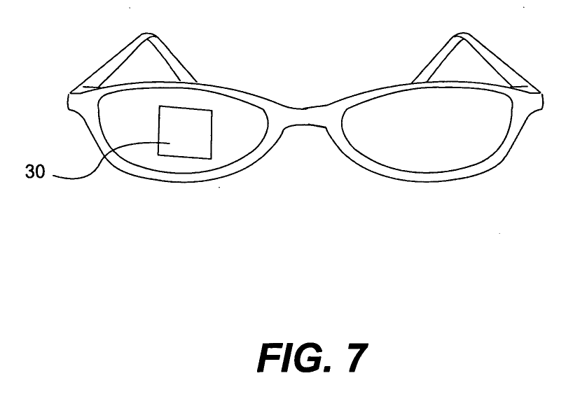

FIGS. 3, 4, 5, and 6 illustrate different embodiments of the platform.

Reverting to FIG. 1, the production center 22 is equipped with a processor 26 and a production machine 28 for producing clip-ons. The processor 26 comprises a user interface and is adapted to receive a remotely acquired image, e.g., a software encoded bitmap or vector graphic, and the reference data used to determine the real size of the eyeglasses.

The production machine is adapted to receive data from the processor, and to produce, in accordance with the data, clip-ons. The production machine may be a milling machine adapted to shape the lenses of one or more clip-ons, drill holes and generate slots, thereby facilitating manufacture, on a non-industrial scale, manufacture of specified clip-ons that match the eyeglasses.

The processor is adapted to receive and process, using the reference data, images of eyeglasses acquired by the remote imaging device 18 at the remote site 20. The processor may comprises a CPU, volatile and non-volatile memory, a user interface, which includes a display and one or more input devices, an interface adapted to communicate with the production machine, and may further include an interface adapted to communicate with a public communication network, such as a LAN, a WAN, the internet, or the PSTN. The processor is also provided with software enabling the functionality described below.

The processor may be adapted to receive images in many formats, including, but not limited to, one of several bitmap or vector formats, with no requirements with regards to noise, white balance, exposure, etc., provided that the image accurately represents the eyeglasses, or can be manipulated in such a way so that it does, such as described below. The processor is adapted to convert the file to a preferred format which the software is adapted to manipulate.

The processor is adapted to receive, or have inputted, information which is used to determine the real size of the eyeglasses. In the event that the information is the A and B dimensions of the eyeglass lenses, the processor is adapted to scale the image horizontally and vertically as described above. The processor may carry out these two calculations independently of one another, since, especially in the event of a facsimile transmission, one dimension may be disproportionately “stretched” or “compressed,” resulting in a distorted image. In the event that the distance from the camera objective to the eyeglasses or the imaged reference dimension is sent, the processor is adapted to geometrically extrapolate the size of the eyeglasses from the information and from the size of the image of the eyeglasses.

The processor is adapted to produce an editable outline of the eyeglasses from the properly sized image. They allow, via the user interface, for the outline to be manually edited. The processor is further adapted to allow for features to be removed or added, as described above. The processor uses the edited outline data to generate commands which are sent to the machine, which produces the clip-ons based on this information.

The processor is adapted to represent the image of the eyeglasses correctly on the user interface. In the event that the user interface comprises a monitor with different vertical and horizontal dimensions for the display pixels, the processor is adapted to compensate for this discrepancy and correctly represent the outline of the eyeglasses to the user for any given monitor.

The processor may also be adapted to acquire an image of eyeglasses locally as described in the US application. In that case, the processor is adapted to indicate which images were captured locally, and which were received from a remote imaging device.

The processor is adapted to process non-digital images. For example, a remote image may be received by a facsimile machine, and the printout converted to a digital image, e.g., by a computer scanner. Processing then continues as described. Alternatively, images may be received in a traditionally photographic medium, either as photographs, photographic negatives, or exposed film. The processor may be adapted to scan photographs and/or photographic negatives. In addition, the production center may further comprise means for developing exposed film.

The processor may comprise software filters used in processing the image, which may include, but are not limited to, noise reduction.

The processor may be adapted to store particulars about the eyeglasses. These particulars may include, but are not limited to, customer information, the manufacturer of the eyeglasses, their model number, and size information. This information may be selectively stored in a database on the machine along with the final edited outline. Based on this, a customer may request additional clip-ons without having his eyeglasses re-imaged. Additionally, a request for clip-ons to fit eyeglasses which are equivalent to one already in the database may proceed directly to production without having to convert and edit the image as described above.

It should be noted that the production center may comprise more than one processor and more than one production machine.

Those skilled in the art to which this invention pertains will readily appreciate that numerous changes, variations and modifications can be made without departing from the scope of the invention mutatis mutandis.

1. A method for providing image information regarding primary eyewear to a remote production center where secondary eyewear is to be produced based thereon, the method comprising:
(a) obtaining with an imaging device an image of said primary eyewear suitable for obtaining therefrom image data indicative of at least one geometric characteristic of the primary eyewear;
(b) providing to the production center reference data associated with the primary eyewear, said reference data being representative of at least one reference dimension; and
(c) transmitting the image data via an external communication means to the production center for production there of said secondary eyewear based on said image data and said reference data.

2. The method according to claim 1, wherein said image data is adapted to be manipulated at least at the production center so that the secondary eyewear will be produced having a size and shape that correspond to those of the primary eyewear.

3. A method according to claim 1, wherein the imaging device comprises a camera objective and a CCD.

4. A method according to claim 3, wherein the imaging device is integrated with a cellular communication device.

5. A method according to claim 4, wherein the cellular communication device is adapted to transmit at least the image data to the production center.

6. A method according to claim 1, wherein the imaging device is a photocopying machine.

7. A method according to claim 1, wherein the image data is transmitted via a facsimile machine.

8. A method according to claim 7, wherein the production center comprises means to convert an image to digital data.

9. A method according to claim 1, wherein the reference data comprises two mutually perpendicular dimensions.

10. A method according to claim 9, wherein the two mutually perpendicular dimensions are measurements of the height and width of at least part of the primary eyewear.

11. A method according to claim 9, wherein the two mutually perpendicular dimensions are associated with an object of known dimensions imaged with the primary eyewear.

12. A method according to claim 11, wherein the object of known dimensions is a sticker which is placed on the primary eyewear during its imaging.

13. A method according to any of the above one of the above claims, wherein the image data is adapted to be used in production of the secondary eyewear.

14. A platform, adapted to hold primary eyewear and an imaging device at a predetermined mutual disposition, such that the imaging device is positioned to image the primary eyewear.

15. A platform according to claim 14 used at a site remote from a production center adapted to produce secondary eyewear based on image data associated with said primary eyewear.

16. A platform according to claim 14, comprising a cover adapted to prohibit lighting conditions unfavorable to clearly imaging the primary eyewear.

17. A platform according to claim 14, comprising a backlight positioned so that the primary eyewear is retained between it and the imaging device.

18. A platform according to claim 17, wherein the intensity of the light is adjustable.

19. A platform according to claim 14, wherein the imaging device is a cellular phone having a digital camera integrated therein.

20. A platform according to claim 14, wherein the distance between the primary eyewear and the imaging device may be adjusted.

21. A platform according to claim 14, wherein the primary eyewear is eyeglasses, the platform being further adapted to hold the primary eyewear such that the temples are not imaged by the imaging device.

22. A production center comprising a processor adapted to receive and process image data and reference data associated with primary eyewear acquired by a remote imaging device, determine the real size of the primary eyewear, and to generate instructions for the production of secondary eyewear; the production center further comprising a production machine adapted to receive the instructions from the processor and to produce secondary eyewear based thereon.

23. A production center according to claim 22, wherein the processor is further adapted to calculate an editable frame outline of the primary eyewear.

24. A production center according to claim 23, wherein the processor is further adapted to calculate supplemental data for the production of secondary eyewear.

25. A production center according to claim 24, wherein the data is locations associated with the outline for attachment of anchoring parts.

26. A production center according to claim 22, wherein the processor comprises several computers.

27. A system comprising a production center adapted to produce therein secondary eyewear based on image data and reference data associated with primary eyewear, the system further comprising a plurality of remote sites for imaging of said primary eyewear.

28. A site adapted to be used with the system disclosed in claim 27.
